(19) United States
(12) Patent Application Publication
(10) Pub. No.: US 2010/0199476 A1
(43) Pub. Date: Aug. 12, 2010

(54) Memorial with cremains

(76) Inventors: Robert S. Cummings, Rochester, MA (US); Paul G. Chuckran, Bridgewater, MA (US)

Correspondence Address: LITMAN LAW OFFICES, LTD., POST OFFICE BOX 41200, SOUTH STATION, ARLINGTON, VA, 22204, US

(21) Appl. No.: 12/320,985

(22) Filed: Feb. 10, 2009

(51) Int. Cl. A61G 17/00; C03B 1/00

(52) U.S. Cl. 27/1; 65/66

(57) ABSTRACT

The memorial with cremains provides a transparent or translucent glass memorial containing the cremains of the deceased with an article(s) of significance to the deceased and/or family and descendents. A method of forming the memorial comprises melting the glass to at least a plastic consistency, mixing the cremains therein, adding the article(s) of significance either in its entirety or disintegrated, optionally adding an inscribed placard within the molten glass, forming the glass to the desired shape, cooling the glass, and adding an inscription directly to the glass or separate placard if not included within the glass earlier. The glass may comprise or contain glass from another article favored by the deceased, e.g., a wine glass or bottle from a favorite beverage, etc. The article included therein may survive in its solid state or may be melted and fused with the glass, depending upon its melting point relative to the glass.

### BACKGROUND OF THE INVENTION

1. Field of the Invention

The present invention relates generally to memorials for deceased persons and animals, and particularly to a memorial with cremains that provides a small household memorial or shrine encapsulating the cremains therein, and to a method of making such a memorial or shrine.

2. Description of the Related Art

More and more people are specifying in their wills that they wish to have their remains cremated, rather than requesting burial after they die. There are several reasons for this, among them the additional expense of burial, the ever-increasing amount of land taken up by cemeteries and burial plots, and the fact that their remains can no longer be practicably moved in the event their descendents relocate to another area. Cremation serves as a response to all of the above problems, but then introduces the problem of storage of the cremated ashes or cremains of the deceased. It is generally considered customary for family or descendents to retain the cremains in an urn or the like provided by the crematorium that performed the process. While a crematorium may provide a selection of a number of different urn styles and configurations, they all still have the general configuration of an urn and are not generally particularly artistic.

Another consideration is that oftentimes the deceased will specify in his or her will that some cherished article be buried or incinerated with them, or perhaps close members of the family may wish to include such an article as an act of remembrance for the deceased. In the case of cremation, this may be practicable for various combustible articles. However, this consideration limits the types of articles that may be incinerated with the cremated remains. Such articles as precious stones, jewelry, hard metal objects, etc., having high melting points are not compatible with the cremation process.

The present inventors are aware of various attempts that have been made in the past to preserve cremains. Among these is International Patent Publication No. WO 2006/103,347, published on Oct. 5, 2006. This publication describes (according to the English abstract; no drawings were included) a method for preserving funereal ashes comprising making a glass object and replacing the flux used in the glassmaking process with the ash from human or animal cremation.

None of the above inventions and patents, taken either singly or in combination, is seen to describe the instant invention as claimed. Thus, a memorial with cremains and method of forming such a memorial solving the aforementioned problems is desired.

### SUMMARY OF THE INVENTION

The memorial with cremains serves as a means of retaining the cremated ash of the deceased in a translucent or transparent glass memorial, along with some other article(s) of significance to the deceased and/or to his or her descendents or family. The additional articles may be encapsulated in their entirety if they are sufficiently small, or may be disintegrated and mixed with the molten glass when the cremains are mixed therein. If the melting point of the added article is lower than that of the molten glass, the article is mixed homogeneously with the glass. Otherwise, it is retained visibly, either in its whole or particulate form.

The glass may be molded, formed, or finished to have any practicable shape as desired. The glass may include or comprise glass from an article favored by the deceased, e.g., a bottle containing an alcoholic or other beverage favored by the deceased, a wine glass, etc. An inscription may be placed upon a placard inserted in the molten glass, provided on the surface of the glass after cooling, or placed upon a separate placard external to the glass memorial object. A base may be provided as desired, with the external placard being installed upon the base, if so desired.

A method of forming the memorial with cremains comprises melting the glass to at least a plastic consistency, mixing the cremains therein, incorporating at least a portion of an article of significance to the deceased and/or descendents and/or family within the molten glass, optionally disintegrating the article of value before mixing it into the molten glass, forming the glass to the desired shape and/or configuration, providing an inscription within or upon the glass or external to the glass, and optionally providing a base for the completed glass memorial.

These and other features of the present invention will become readily apparent upon further review of the following specification and drawings.

### BRIEF DESCRIPTION OF THE DRAWINGS

FIG. 1 is an environmental, perspective view of a first embodiment of a memorial with cremains according to the present invention, showing its general features.

FIG. 2 is an environmental perspective view of a second embodiment of a memorial with cremains according to the present invention, showing alternative features.

FIG. 3 is an environmental perspective view of a third embodiment of a memorial with cremains according to the present invention, showing further alternative features.

FIG. 4 is a flow chart showing the general steps in a method of forming a memorial with cremains according to the present invention.

Similar reference characters denote corresponding features consistently throughout the attached drawings.

### DETAILED DESCRIPTION OF THE PREFERRED EMBODIMENTS

The memorial with cremains comprises a relatively small memorial incorporating at least a portion of the cremains of the deceased therein. The cremains may be human or animal (e.g., a cherished pet, etc.), and are molded into the glass matrix in its molten state. At least a portion of some other article of significance to the deceased, and/or to his or her family and/or descendents, is also molded into the glass matrix at the time of manufacture of the memorial. It is expected that most such memorials will be of relatively small size for display upon a shelf or the like in the home or other interior environment. Thus, it may not be possible to place the entire cremains of the deceased, or all of an article of significance, into the glass matrix. The amount will vary depending upon the quantity of the cremains, the amount of material from the article of significance, and the size of the memorial to be produced.

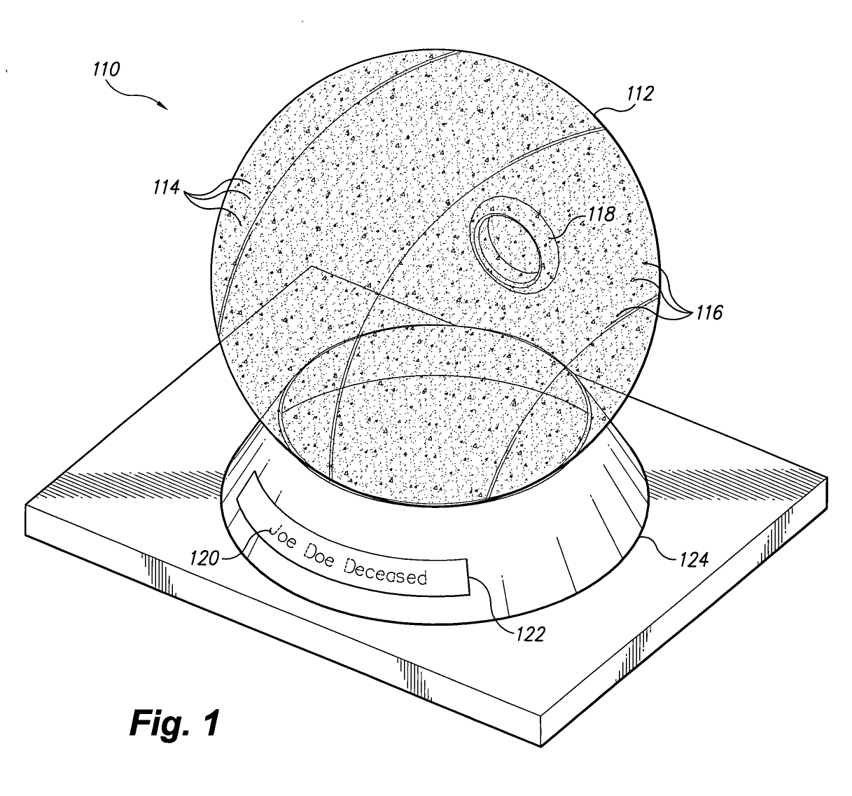

FIG. 1 of the drawings provides an illustration of a first embodiment of the memorial, designated as memorial 110. The memorial 10 primarily comprises a glass matrix 112 having at least a portion of the cremains of the deceased molded and encapsulated therein, as indicated by the particulate matter 114 visible within the glass matrix. The glass matrix 112 also contains particles 116 of an article of significance to the deceased, which particles 116 are mixed and blended with the cremains 114 and blended and molded into the glass matrix 112 while it is in a molten state. The various particulate cremains 114 and significant article particles 116 may be mixed and blended homogeneously throughout the glass matrix 112, or may be left as relatively unmixed areas within the matrix 112, if so desired.

Also visible in the glass matrix of FIG. 1 is a complete article of significance 118, e.g., a wedding band or ring or other jewelry, etc. It will be understood that the integrity of such an article of significance 118 within the glass matrix 112, or for that matter the particulate article 116, will depend upon the melting point of the article relative to the glass of the matrix 112. In the example of FIG. 1, the particles 116 and whole article 118 are encapsulated within the glass matrix 112 in their entireties, as they have melting points higher than that of the glass. The melting point of glass can vary considerably, depending upon the type of glass and its ingredients, and further the melting point is not a single temperature, as glass tends to soften and become plastic at a lower temperature than its absolutely liquid state. Cremains will universally have a higher melting point than will the glass of the matrix 112, as will many precious stones and certain metals such as platinum, nickel, and many steels. However, most jewelry uses softer precious metals such as gold and silver, and such metals will melt and blend with the molten glass of the matrix 112 during the manufacture of the memorial 110. Regardless of the specific materials mixed into the molten glass matrix 112, the result is a glass structure devoid of holes, passages, or other voids therein or extending from the exterior of the matrix into its interior.

In addition to the above materials, other glass of significance to the deceased, and/or of significance to his or her family and/or descendents, may be blended with the molten glass matrix 112, or used in lieu of a specialized glass for the matrix, if so desired. Such other glass of significance may comprise glass from a drinking glass or perhaps a bottle for an alcoholic or non-alcoholic beverage, etc., as desired. For example, a married couple may have kept a champagne glass(es) and/or a bottle from champagne served at their wedding, which glass may be blended with the remainder of the glass comprising the matrix 112. As another example, glass from the eyeglasses of the deceased might be incorporated. The above examples are by no means exhaustive.

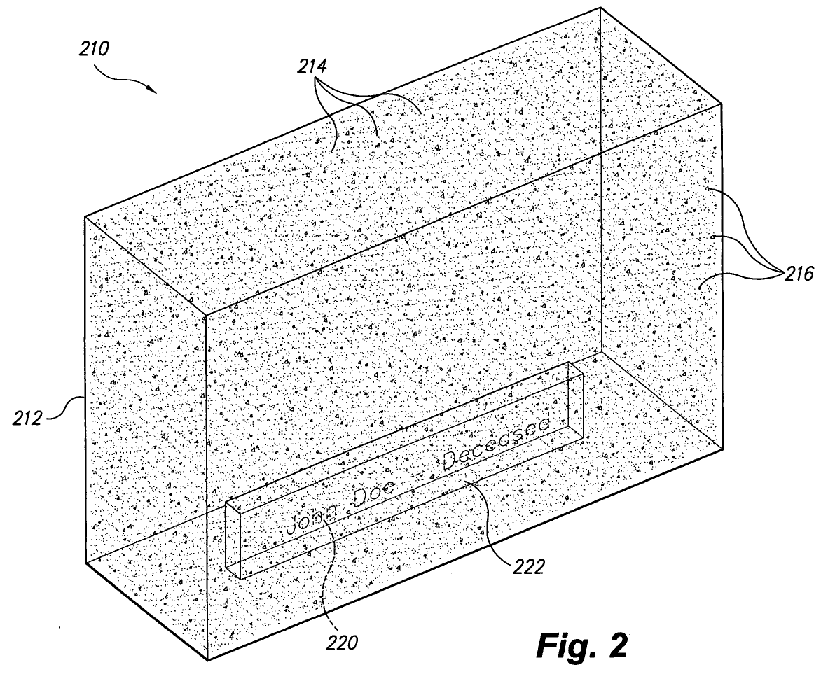

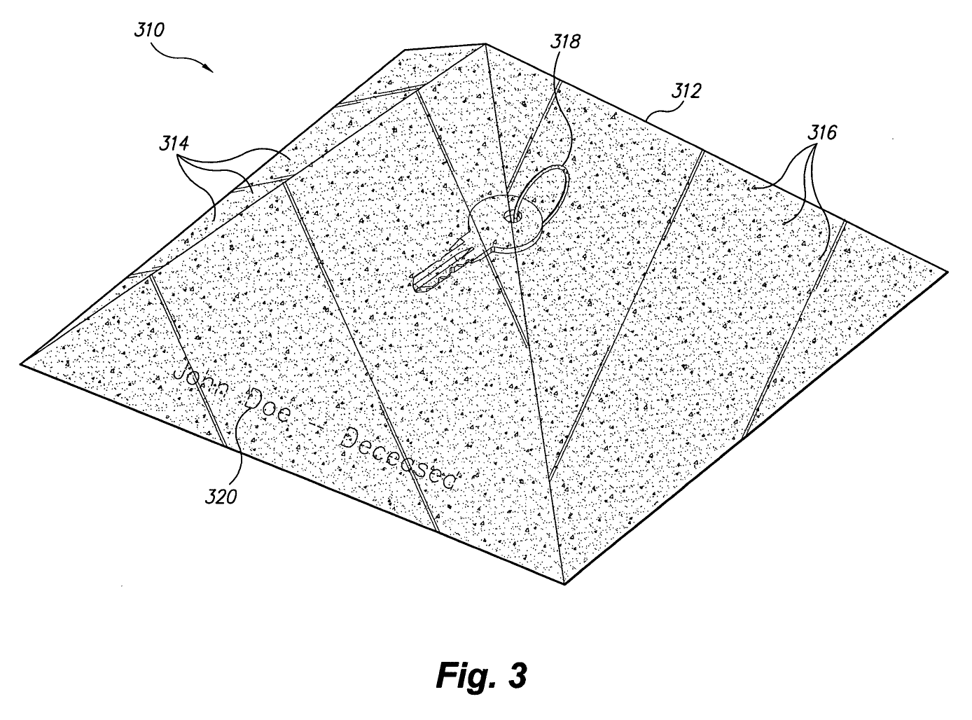

Preferably, an inscription 120 is provided for the memorial. In the example of FIG. 1, the inscription 120 is applied to a placard 122, which is in turn placed upon a base 124 supporting the spherical glass matrix 112. The base 124 may be of any practicable configuration and material as desired, e.g., additional glass, wood, metal, plastic, etc, with the glass 112 either removably installed upon the base 124 or permanently affixed thereto. It will be seen that the inscription may be applied in different ways and to different areas upon, in, or near the glass matrix 112 of the memorial, as desired. Other examples are shown in FIGS. 2 and 3 and discussed below.

FIG. 2 of the drawings provides a perspective view of a second embodiment of the memorial with its cremains, designated by the reference numeral 210. Corresponding components in each embodiment are designated by reference numerals differing by 100 from one another, e.g., the memorials 110 and 210 of FIGS. 1 and 2, etc. The memorial embodiment 210 of FIG. 2 is formed as a rectangular solid, although it could have any of a vast number of different shapes as desired. The memorial 210 comprises a glass matrix 212 having at least some of the cremains 214 of the deceased blended therein. Other material 216 from an article or articles of significance to the deceased and/or the family and/or descendents of the deceased are also blended into the glass matrix 212, as in the case of the first memorial 110 of FIG. 1. Additional glass from another source, and/or a whole article of significance (not shown in FIG. 2), may be blended with the glass matrix 212 as desired.

The primary difference between the memorial 210 of FIG. 2 and the memorial 110 of FIG. 1, other than their different shapes, is that the memorial 210 encapsulates the plaque or placard 222 with its inscription 220 within the glass matrix 212. This is accomplished by inserting the previously inscribed placard 222 into the molten glass during the manufacture of the memorial. Obviously, the placard 222 is formed of a material (e.g., stainless steel, or perhaps platinum, etc.) having a higher melting point than the various glass compounds forming the matrix 212. The molten glass flows around the placard 222, thereby encapsulating the inscribed placard completely within the glass matrix 212. In the case of a memorial such as the memorial 212 of FIG. 2 having a flat bottom surface, a separate base may not be required or desired, particularly as the inscription is contained integrally with the glass matrix 212.

FIG. 3 illustrates yet another embodiment of the memorial with cremains, wherein the glass matrix 312 of the memorial 310 is molded or otherwise formed in the shape of a pyramid. As in the other embodiments of FIGS. 1 and 2 discussed further above, the glass matrix 312 contains at least some of the cremains 314 of the deceased, along with an additional article 216, or disintegrated fragments thereof, of significance to the deceased and/or his or her family and/or descendents. In the example of FIG. 3, a key is shown as the article of significance within the glass matrix 212, which might be an appropriate article for placement within the matrix 212 in the case of the deceased having a favored car, boat, or other vehicle to which the key belonged. Other examples of articles relating to the profession of the deceased might be a law enforcement badge or similar article.

Alternatively, the deceased may have owned a favorite classic automobile, boat, or aircraft, in which case a set of keys to the vehicle might be molded into the glass matrix 212. Where such keys or other articles are formed of brass or other soft metal with a low melting point, it will be seen that the article will melt and blend with the molten glass of the matrix during manufacture. Other articles having higher melting points may retain their integrity for viewing as a whole in the completed memorial 300. The above examples are just that, i.e., exemplary, and are not intended to imply any limitation as to the type(s) of article(s) of significance that might be blended into the glass matrix in any of the embodiments of the memorial. Some small portion of a favorite article of sports equipment, e.g., fishing pole, golf club, etc. might be ground up or otherwise processed for blending into the glass matrix, as desired.

The inscription 320 of the memorial 300 differs from the embodiments of FIGS. 1 and 2 in that the inscription is engraved, etched, or otherwise formed directly onto the outer surface of the matrix 312. In this manner the necessity of a separate plaque or placard is avoided. It will be understood that the engraving or other formation of the inscription directly onto the surface of the glass matrix may be accomplished with either of the other examples of FIGS. 1 and 2, and/or the provision of a placard and inscription as shown in FIG. 1 or 2 may be used for display of the inscription of the example of FIG. 3, if so desired.

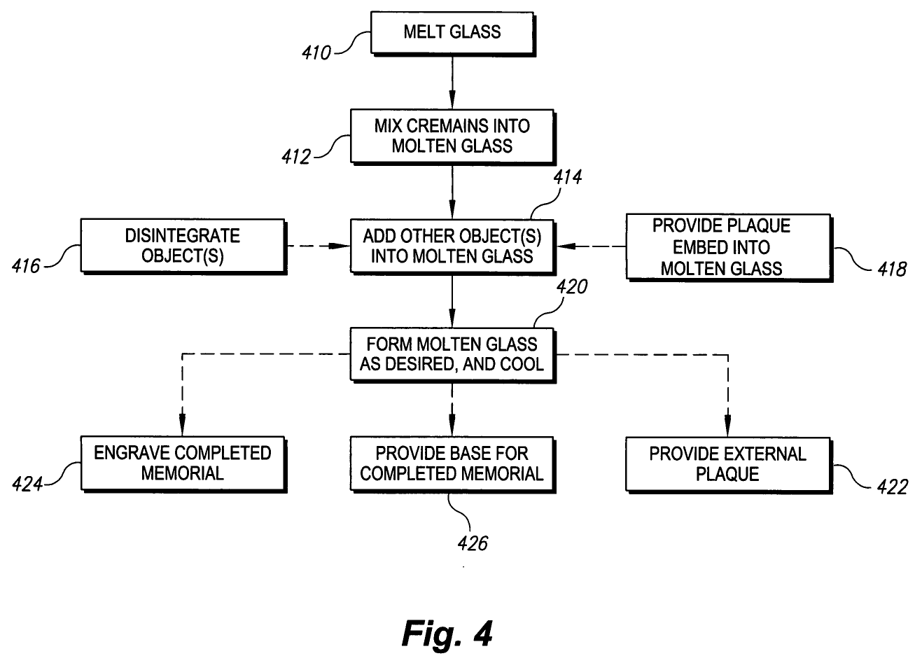

FIG. 4 is a flow chart describing the basic steps in the method of forming a memorial with cremains. Initially, the glass to be used to form the matrix is melted, generally as indicated by the first step 410 of FIG. 4. The glass need not be melted to a particularly viscosity, but must be melted sufficiently to allow the mixing and inclusion of other materials therein, as discussed further above. Simultaneously with the melting of the primary glass material provided to form the matrix, any other glass materials desired may be broken up and mixed with the molten glass.

When the glass has been melted to the degree required, at least a portion of the cremains are mixed into the molten glass as indicated by the second step 412 of FIG. 4, with the quantity or percentage being variable as desired. As noted further above, it is unlikely that all of the cremains can be added to the glass matrix, as the completed memorial is intended to be relatively small. However, in some instances, e.g., a larger outdoor memorial incorporating perhaps one or more cubic feet of glass, it may be possible to mix the entire cremains into the molten glass.

Simultaneously with the mixing or blending of the cremains into the molten glass, other object(s) or article(s) of significance may be added to the molten glass mix, generally as indicated by the third step 414 of FIG. 4. Again, it may not be possible to include the entire object or article into the molten glass matrix; this may be adjusted as required or desired. In instances where the article must be ground or broken up, the object or article is disintegrated prior to mixing into the molten glass, as indicated by the optional fourth step 416 of FIG. 4.

Prior to this point, the determination of the type or configuration of inscription must be made. This is because in some cases the placard with its inscription is to be incorporated within the glass matrix, as in the example of FIG. 2, and as no holes or passages are provided in or into the matrix, the placard must be added at the time the glass is still in its molten state. This is indicated generally by the optional fifth step 418 of FIG. 4.

When the various additives (cremains, article of significance, optional placard) have been mixed into or added to the molten glass, the glass is molded or otherwise formed to the desired shape and allowed to cool and harden, generally as indicated by the sixth step 420 of FIG. 4. If no plaque and inscription have been molded into the glass matrix while the matrix was in its molten state per the fifth step 418 described further above, the placard and inscription is added after the glass cools and hardens. The external inscription may be in one of two general forms or types. The first form or type is the external placard and inscription applied either to the glass matrix or placed adjacent to the matrix, e.g., on a base or the like, as shown in the embodiment of FIG. 1 and indicated as the seventh step 422 of FIG. 4. Alternatively, the inscription may be applied directly to the surface of the glass matrix, as indicated by the eighth step 424 of FIG. 4 and shown in FIG. 3. The seventh and eighth steps 422 and 424 of FIG. 4 are indicated as optional, as they are not applicable if the placard and inscription have been molded integrally into the molten glass per step 418 of FIG. 4. Finally, a base may be provided optionally as desired, as indicated by the optional ninth step 426 of FIG. 4.

In conclusion, the memorial with cremains provides a means for family and descendents to remain close to the deceased, without the conventional urn and potential difficulties associated therewith. The cremains contained within the memorial, as well as other articles of significance, cannot spill or be lost from the molded glass matrix encapsulating them. In many cases it may not be possible for all of the cremains to be incorporated into a single glass matrix for a single memorial. In such situations, those involved may desire to have two (or more) such memorials manufactured, with each containing some portion of the cremains of the deceased and some portion of an article or articles of significance. In this manner multiple members of a family, e.g., surviving children who may have moved to different areas of the country, may each have a memorial to the deceased without concern about the location of a single burial plot or cremation urn. The result will be much appreciated by surviving family members and descendents of the deceased.

It is to be understood that the present invention is not limited to the embodiments described above, but encompasses any and all embodiments within the scope of the following claims.

We claim:

1. A memorial with cremains, comprising:
a translucent glass matrix, at least a portion of the cremains of a deceased to whom the memorial relates being mixed into the glass matrix and molded therein; and
at least a portion of an article of significance to the deceased molded into the glass matrix.

2. The memorial with cremains according to claim 1, further comprising an inscription disposed with the glass matrix.

3. The memorial with cremains according to claim 2, wherein the inscription is disposed upon a placard, the placard being molded into the glass matrix.

4. The memorial with cremains according to claim 2, wherein the inscription is disposed directly upon the glass matrix.

5. The memorial with cremains according to claim 2, wherein the inscription is disposed upon a placard, the placard being disposed externally to the glass matrix.

6. The memorial with cremains according to claim 1, further including glass from a glass object of significance to the deceased, mixed and molded with the glass matrix.

7. A method of forming a memorial with cremains using the apparatus of claim 1, comprising the steps of:
(a) melting the glass matrix to at least a plastic consistency;
(b) mixing at least a portion of the cremains of the deceased into the molten glass matrix;
(c) mixing at least a portion of the article of significance to the deceased into the molten glass matrix;
(d) forming the molten glass matrix to a desired shape; and
(e) cooling the glass matrix.

8. The method of forming a memorial with cremains according to claim 7, wherein the step of mixing at least a portion of the article of significance further comprises mixing glass obtained from the article of significance to the deceased into the molten glass matrix.

9. The method of forming a memorial with cremains according to claim 7, further comprising the step of disintegrating at least a portion of the article of significance to the deceased, prior to mixing the article of significance into the molten glass matrix.

10. The method of forming a memorial with cremains according to claim 7, further comprising the step of forming an inscription relevant to the deceased for the memorial.

11. The method of forming a memorial with cremains according to claim 10, wherein the step of forming an inscription comprises:
(a) applying the inscription to a placard; and
(b) molding the placard into the molten glass matrix.

12. The method of forming a memorial with cremains according to claim 10, wherein the step of forming an inscription comprises inscribing the glass matrix directly after cooling.

13. The method of forming a memorial with cremains according to claim 10, wherein the step of forming an inscription comprises:
(a) applying the inscription to a placard; and
(b) installing the inscribed placard adjacent to the glass matrix.

14. A method of forming a memorial with cremains, comprising the steps of:
(a) melting a mass of glass to at least a plastic consistency;
(b) mixing at least a portion of the cremains of the deceased into the molten glass matrix;
(c) molding at least a portion of an article of significance to the deceased, into the molten glass matrix;
(d) forming the molten glass matrix to a desired shape; and
(e) cooling the glass matrix.

15. The method of forming a memorial with cremains according to claim 14, further comprising the step of mixing glass obtained from an article of significance to the deceased into the molten glass matrix.

16. The method of forming a memorial with cremains according to claim 14, further comprising the step of disintegrating at least a portion of the article of significance to the deceased, prior to mixing the article of significance into the molten glass matrix.

17. The method of forming a memorial with cremains according to claim 14, further comprising the step of forming an inscription relevant to the deceased for the memorial.

18. The method of forming a memorial with cremains according to claim 17, wherein the step of forming an inscription comprises
(a) applying the inscription to a placard; and
(b) molding the placard into the molten glass matrix.

19. The method of forming a memorial with cremains according to claim 17, wherein the step of forming an inscription comprises inscribing the glass matrix directly after cooling.

20. The method of forming a memorial with cremains according to claim 17, wherein the step of forming an inscription comprises:
(a) applying the inscription to a placard; and
(b) installing the inscribed placard adjacent to the glass matrix.
